(19) United States
(12) Patent Application Publication
(10) Pub. No.: US 2026/0266979 A1
(43) Pub. Date: Sep. 10, 2026

(54) ROUND TRIP TIME CARRIER PHASE POSITIONING

(71) Applicant: Nokia Technologies Oy, Espoo (FI)

(72) Inventors: Satya Krishna JOSHI, Oulu (FI); Ryan KEATING, Chicago, IL (US); Hyun-Su CHA, Chicago, IL (US); Dileep KUMAR, Espoo (FI); Aki HEKKALA, Oulu (FI)

(21) Appl. No.: 19/153,603

(22) PCT Filed: Oct. 19, 2023
(86) PCT No.: PCT/EP2023/079080

§ 371 Date: Aug. 5, 2025

Related U.S. Application Data
(60) Provisional application No. 63/446,574, filed on Feb. 17, 2023.

(51) Int. Cl. G01S 13/76; H04W 64/00

(52) U.S. Cl. CPC G01S 13/765; H04W 64/00

(57) ABSTRACT

Round trip time carrier phase positioning considering coherence time for initial phase offset is provided. A method for round trip time carrier phase positioning may include receiving an uplink reference signal from a user equipment and determining a coherence time of a phase-offset. The method may further include determining a round-trip time interval between a transmission time of the uplink reference signal and a reception time of a downlink reference signal, and reporting, to a location management function of a network, a carrier phase measurement and a time differential between the coherence time and the round-trip time interval.

### TECHNICAL FIELD

Some example embodiments may generally relate to mobile or wireless telecommunication systems, such as Long Term Evolution (LTE) or fifth generation (5G) new radio (NR) access technology, or 5G beyond, or other communications systems. For example, certain example embodiments may relate to round trip time carrier phase positioning.

### BACKGROUND

Examples of mobile or wireless telecommunication systems may include the Universal Mobile Telecommunications System (UMTS) Terrestrial Radio Access Network (UTRAN), Long Term Evolution (LTE) Evolved UTRAN (E-UTRAN), LTE-Advanced (LTE-A), MulteFire, LTE-A Pro, and/or fifth generation (5G) radio access technology or new radio (NR) access technology. Fifth generation (5G) wireless systems refer to the next generation (NG) of radio systems and network architecture. 5G network technology is mostly based on new radio (NR) technology, but the 5G (or NG) network can also build on E-UTRAN radio. It is estimated that NR may provide bitrates on the order of 10-20 Gbit/s or higher, and may support at least enhanced mobile broadband (eMBB) and ultra-reliable low-latency communication (URLLC) as well as massive machine-type communication (mMTC). NR is expected to deliver extreme broadband and ultra-robust, low-latency connectivity and massive networking to support the Internet of Things (IoT).

### SUMMARY

Various exemplary embodiments may provide an apparatus including at least one processor and at least one memory storing instructions. The stored instructions, when executed by the at least one processor, cause the apparatus at least to receive an uplink reference signal from a user equipment and determine a coherence time of a phase-offset. The apparatus may further be caused to determine a round-trip time interval between a transmission time of the uplink reference signal and a reception time of a downlink reference signal and determine whether a bi-directional phase measurement condition is satisfied by calculating whether the round-trip time interval is less than the coherence time.

Certain exemplary embodiments may provide an apparatus including at least one processor and at least one memory storing instructions. The stored instructions, when executed by the at least one processor, cause the apparatus at least to transmit an uplink reference signal to a plurality of network entities, which is configured to be used to calculate a coherence time of a phase-offset, and receive, from one or more of the plurality of network entities, a downlink reference signal when a round-trip time interval is less than the coherence time of the phase-offset, wherein the round-trip time interval is a time interval between a transmission time of the uplink reference signal and a reception time of the downlink reference signal by each of the one or more of the plurality of network entities. The apparatus may be further caused to determine a downlink phase based on the downlink reference signal received from the one or more of the plurality of network entities.

Some exemplary embodiments may provide an apparatus including at least one processor and at least one memory storing instructions. The stored instructions, when executed by the at least one processor, cause the apparatus at least to receive, from one or more network entities, a report indicating an uplink carrier phase measurement and a time differential between a coherence time and a round-trip time interval based on reference signals of the one or more network entities. The apparatus may be further caused to receive, from a user equipment, a report indicating a downlink carrier phase measurement, and perform bi-directional carrier phase measurement based on at least the uplink and downlink carrier phase measurements and information related to the coherence time.

Certain exemplary embodiments may provide an apparatus including means for receiving an uplink reference signal from a user equipment and means for determining a coherence time of a phase-offset. The apparatus may further include means for determining a round-trip time interval between a transmission time of the uplink reference signal and a reception time of a downlink reference signal, and means for determining whether a bi-directional phase measurement condition is satisfied by calculating whether the round-trip time interval is less than the coherence time.

Various exemplary embodiments may provide an apparatus including means for transmitting an uplink reference signal to a plurality of network entities, which is configured to be used to calculate a coherence time of a phase-offset. The apparatus may further include means for receiving, from one or more of the plurality of network entities, a downlink reference signal when a round-trip time interval is less than the coherence time of the phase-offset. The round-trip time interval may be a time interval between a transmission time of the uplink reference signal and a reception time of the downlink reference signal by each of the one or more of the plurality of network entities. The apparatus may further include means for determining a downlink phase based on the downlink reference signal received from the one or more of the plurality of network entities.

Various exemplary embodiments may provide an apparatus including means for receiving, from one or more network entities, a report indicating an uplink carrier phase measurement and a time differential between a coherence time and a round-trip time interval based on reference signals of the one or more network entities. The apparatus may further include means for receiving, from a user equipment, a report indicating a downlink carrier phase measurement, and means for performing bi-directional carrier phase measurement based on at least the uplink and downlink carrier phase measurements and information related to the coherence time.

Some exemplary embodiments may provide a method including receiving an uplink reference signal from a user equipment and determining a coherence time of a phase-offset. The method may further include determining a round-trip time interval between a transmission time of the uplink reference signal and a reception time of a downlink reference signal, and determining whether a bi-directional phase measurement condition is satisfied by calculating whether the round-trip time interval is less than the coherence time.

Certain exemplary embodiments may provide a method including transmitting an uplink reference signal to a plurality of network entities, which is configured to be used to calculate a coherence time of a phase-offset. The method may also include receiving, from one or more of the plurality of network entities, a downlink reference signal when a round-trip time interval is less than the coherence time of the phase-offset. The round-trip time interval may be a time interval between a transmission time of the uplink reference signal and a reception time of the downlink reference signal by each of the one or more of the plurality of network entities. The method may further include determining a downlink phase based on the downlink reference signal received from the one or more of the plurality of network entities.

Various exemplary embodiments may provide a method including receiving, from one or more network entities, a report indicating an uplink carrier phase measurement and a time differential between a coherence time and a round-trip time interval based on reference signals of the one or more network entities. The method may also include receiving, from a user equipment, a report indicating a downlink carrier phase measurement, and performing bi-directional carrier phase measurement based on at least the uplink and downlink carrier phase measurements and information related to the coherence time.

Various exemplary embodiments may provide a non-transitory computer readable storage medium storing instruction that, when executed by at least one processor of an apparatus, causes the apparatus at least to perform one or more methods described herein. Some exemplary embodiments may provide a computer program including instructions that, when executed by an apparatus, cause the apparatus to perform one or more methods described herein. Certain exemplary embodiments may provide an apparatus including one or more circuitry configured to perform one or more methods described herein.

### BRIEF DESCRIPTION OF THE DRAWINGS

For proper understanding of example embodiments, reference should be made to the accompanying drawings, as follows:

FIG. 1 illustrates an example of a bi-directional carrier phase measurement under ideal conditions;

FIG. 2 illustrates an example of a time duration for a carrier phase measurement procedure;

FIGS. 3A and 3B illustrate an exemplary signal diagram for bi-directional carrier phase measurement and positioning, according to various exemplary embodiments;

FIGS. 4A and 4B illustrate another exemplary signal diagram for bi-directional carrier phase measurement and positioning, according to certain exemplary embodiments;

FIG. 5 illustrates an example of a flow diagram of a method, according to various exemplary embodiments;

FIG. 6 illustrates an example of a flow diagram of another method, according to various exemplary embodiments;

FIG. 7 illustrates an example of a flow diagram of a further method, according to certain exemplary embodiments; and

FIG. 8 illustrates a set of apparatuses, according to various exemplary embodiments.

### DETAILED DESCRIPTION

It will be readily understood that the components of certain example embodiments, as generally described and illustrated in the figures herein, may be arranged and designed in a wide variety of different configurations. The following is a detailed description of some exemplary embodiments of systems, methods, apparatuses, and non-transitory computer program products for round trip time carrier phase positioning considering coherence time for initial phase offset. Although the devices discussed below and shown in the figures refer to 5G or Next Generation NodeB (gNB) devices and user equipment (UE) devices, this disclosure is not limited to only gNBs and UEs.

It may be readily understood that the components of certain example embodiments, as generally described and illustrated in the figures herein, may be arranged and designed in a wide variety of different configurations. Different reference designations from multiple figures may be used out of sequence in the description, to refer to a same element to illustrate their features or functions. If desired, the different functions or procedures discussed herein may be performed in a different order and/or concurrently with each other. Furthermore, if desired, one or more of the described functions or procedures may be optional or may be combined. As such, the following description should be considered as illustrative of the principles and teachings of certain example embodiments, and not in limitation thereof.

In 5G/NR technology, as well as LTE, positioning is performed by transmitting/receiving signals between a user equipment (UE) and a network entity, such as a location server or location management function (LMF). The accuracy, integrity, and power efficiency of positioning in NR technology continues to be important considerations. One method of performing positioning in NR technology is carrier phase positioning, which analyzes, for example, positioning reference signals (PRSs). Carrier phase positioning may rely on a user equipment (UE) for measuring a phase of a downlink (DL) signal and reporting the measured phase of the DL signal to the network.

This UE-assisted NR carrier phase positioning may consider a carrier phase measured from the DL PRS signal of a reference transmission reception point (TRP), and/or a difference between the carrier phase measured from the DL PRS signal of a target TRP and the carrier phase measured from the DL PRS signal of a reference TRP. For uplink (UL) UE-assisted NR carrier phase positioning, the carrier phase measured from an UL sounding reference signal (SRS) may be consider for determining positioning. Round trip time (RTT) type measurements, also known as bi-directional carrier phase measurements, may be supported.

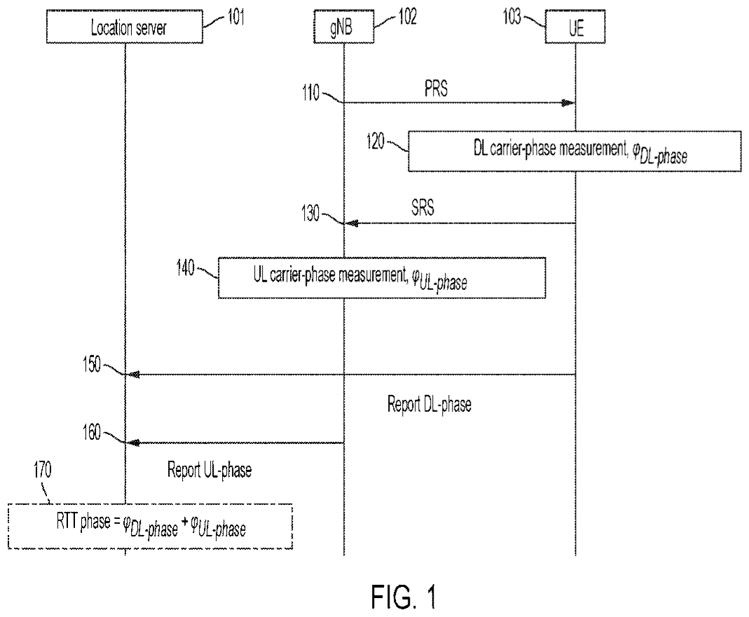

FIG. 1 illustrates an example of a bi-directional RTT carrier phase measurement. In FIG. 1, at 110, a base station, such as a gNB 102, may transmit a PRS to a UE 103. At 120, the UE 103 may perform a DL carrier phase measurement φ_{DL-phase} based on the PRS received at 110, and at 130, the UE 103 may transmit an SRS to the gNB 102. At 140, the gNB 102 may perform UL carrier phase measurement φ_{UL-phase} based on the SRS received at 130. At 150, the UE 103 may report the DL carrier phase measurement φ_{DL-phase}, measured at 120, to a location management function (LMF) 101 of the network, and, at 160, the gNB 102 may report the UL carrier phase measurement φ_{UL-phase}, measured at 120, to the LMF 101. At 170, the RTT phase may be determined as RTT phase=φ_{DL-phase}+φ_{UL-phase} by using the measurements received at 150 and 160.

A DL carrier-phase observable equation in carrier phase positioning using the DL carrier-phase measurement may be expressed as:

$${φ}_{DL - phase} + N = d / λ + {φ}_{DL 0} \qquad ( 1 )$$

A UL carrier-phase observable equation in carrier phase positioning using the UL carrier-phase measurement may be expressed as:

$${φ}_{UL - phase} + N = d / λ - {φ}_{U L 0} \qquad ( 2 )$$

In these equations, φ_{DL-phase} may be a measured phase at the UE in a cycle, N may be the total number of full carrier cycles, A may be a carrier wavelength, and φ_{DL0} may be an initial phase offset, which may be caused by, for example, timing alignment errors, time offsets, frequency offsets, local oscillator (LO) initial phases, etc., of the transmitter(s) and/or receiver(s). A measured DL carrier-phase may be a function of distance (d) and carrier wavelength (λ), for static gNB and UE, and given by

$${φ}_{DL - phase} = \frac{2 π d}{λ} ( mod 2 π )$$

radian. The phase observable equation may be expressed in terms of cycle′ such that the measurements are divided by 2π.

A phase offset variation may be caused by various hardware specific issues of gNBs and UEs. The phase offset variation may be a speed at which the phase offset may vary as a function of time. This phase offset variation may be quantified using coherence-time. Under an ideal coherence-time condition, the initial phase offsets may be φ_{DL0}=φ_{UL0}=φ₀ and the expressions may be expressed as;

$$For DL : {φ}_{DL - phase} + N = d / λ + {φ}_{0} , \qquad ( 3 )$$

$$For UL : {φ}_{UL - phase} + N = d / λ - {φ}_{0} . \qquad ( 4 )$$

These equations may be solved to result in a bi-directional carrier phase, φ_{BD-phase}, observable equation, which may be expressed as:

$${φ}_{BD - phase} = {φ}_{DL - phase} + {φ}_{UL - phase} = 2 N + 2 d / λ \qquad ( 5 )$$

In this bi-directional carrier phase expression, the unknown initial phase offsets φ₀ may be cancelled out and may provide an improved accuracy positioning. The intrinsic integer ambiguity N may be resolved by using a virtual wavelength, which is based on measuring the UL and/or DL carrier phases over two distinct frequency tones, such as using resource elements, PFLs, etc., at a serving gNB and a target UE, such that the processes of FIG. 1 may be performed again. Thus, an achievable range ambiguity may be inversely proportional to Δ_{f} (spacing between frequency tones), which may be a design parameter for resolving integer ambiguity.

The above-described bi-directional carrier phase expression is based on ideal conditions. However, the real-world may not have ideal conditions. In non-ideal conditions, there may be a time gap between the UL and DL carrier phase measurements.

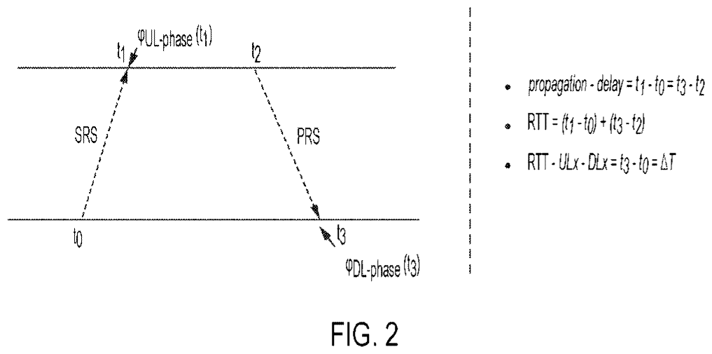

FIG. 2 illustrates a time duration for the carrier phase measurement procedure. The time duration may include the RTT and/or the time between DL and UL reference-signal transmissions, receptions, and corresponding radio measurement. This is a time-duration of ΔT=t₃−t₀ in FIG. 2, in which ΔT is RTT-ULx-DLx representing the overall time duration over which a bi-directional (RTT) carrier phase measurement procedure occurs.

During the time period ΔT [time-units], the initial phase offset φ₀ varies depending on, for example, the hardware-specific issues of the gNB and UE. Due to the variation in the initial phase offset φ₀ during ΔT, the complete cancellation of the initial phase offset φ₀ cannot be achieved because the phase offset will drift over time from, for example, the oscillator drift. The timing between the DL and UL transmissions may also contribute to the drift in the phase offset over the ΔT.

In view of the above, there may be a need to suppress or prevent the initial phase offsets during UL and DL measurements from changing significantly, or restricted to be within a tolerable level. Various exemplary embodiments described herein may provide advantages to resolve issues known in the technology, such as the issues discussed above. For example, certain exemplary embodiments may advantageously provide one or more procedures to increase the accuracy of carrier phase-based positioning by the RTT-ULx-DLx duration ΔT of the UL and DL carrier phase measurements being within the coherence-time induced by the initial phase-offset variations due to hardware impairments over time, even for the static UE.

Certain exemplary embodiments may provide one or more procedures to account for the coherence-time induced by the initial phase-offset variations due to hardware impairments for bi-directional (RTT) carrier phase positioning. Various exemplary embodiments may provide one or more exemplary procedures. In an exemplary procedure, one or more gNBs, such as three gNBs, and a UE that may be configured for bi-directional carrier phase positioning. The gNBs may be configured with a downlink positioning reference signal (DL-PRS), and/or other reference signals, for DL carrier phase measurement at the UE. The UE may be configured with an SRS, and/or other reference signals, for UL carrier phase measurements at the gNBs.

In an exemplary procedure, a coherence-time induced by the initial phase-offset variations may be estimated for each gNB and UE pair. A sequence of RTT-carrier phase measurement may start with UL-SRS transmission, which enables all gNBs to perform measurement, for example, at a similar or simultaneous time, using SRS. An LMF may signal the UE and the gNBs to follow the sequence of transmissions during bi-directional carrier phase positioning initiation. In the sequence of transmissions, the UE may perform a transmission first, followed by the gNBs. Each of the gNBs may estimate and/or update a coherence time

$${T}_{gNB \_ x}^{c}$$

induced by the phase-offset variations using periodic reception of SRS.

According to some exemplary embodiments, the UE may be configured to transmit one or more signals other than the SRS. The LMF may signal the UE and the gNBs to start with the coherence time estimation period. The LMF may request the gNBs and/or the UE to report the estimated coherence time. All of the gNBs may estimate the coherence time

$${T}_{gNB \_ x}^{c} .$$

and then the gNBs and UE may initiate bi-directional carrier phase measurements. The gNBs may then estimate UL carrier phase estimation and propagation delay by using SRS or the other reference signals.

Certain exemplary embodiments provide that the DL-carrier phase measurements (PRS transmissions) may account for the coherence time

$${T}_{gNB \_ x}^{c}$$

by each gNB, using one or more exemplary procedures. Each gNB may calculate a difference value TgNB_xc−ΔT_{gNB_x}, and report the difference values to the LMF. The LMF may then use difference values as soft information for filtering the gNBs for positioning estimation of UE.

As an exemplary procedure, the gNBs may estimate the RTT-ULx-DLX ΔT_{gNB_x} considering the estimated propagation delay during the UL-SRS transmission phase and the next PRS-time instances. The gNBs may transmit PRSs when the RTT-ULx-DLX ΔT_{gNB_x} of the gNBs is smaller than the coherence time

$${T}_{gNB \_ x}^{c} .$$

Each gNB may signal to the LMF whether or not the achieved RTT-ULx-DLx and the coherence-time condition have been satisfied. As another example, the gNBs may transmit the PRSs and, if applicable, information indicating that the RTT-ULx-DLX ΔT_{gNB_x} is not smaller than the coherence time

$${T}_{gNB \_ x}^{c} .$$

As another exemplary procedure, all of the gNBs may transmit a PRS to the UE without checking the coherence time conditions. Each gNB may signal to the LMF whether or not the achieved RTT-ULx-DLx and the coherence-time condition have been satisfied.

As a further exemplary procedure, the UE may initially estimate the coherence time and signal the estimated coherence time to the LMF. Then the gNBs may receive the estimated coherence time from the LMF and transmit a PRS accordingly to meet the estimated coherence time.

According to various exemplary embodiments, after the LMF uses RTT measurements, and hard information and soft information on coherence time status from multiple gNBs, the LMF may calculate a location/position of the UE location legacy positioning algorithms. The hard information may be a value, such as a binary value, e.g., true or false, to indicate whether a condition has been met or not. The soft information may be a value of a difference or a margin related to the condition of the hard information, which may be provided in addition to the hard information.

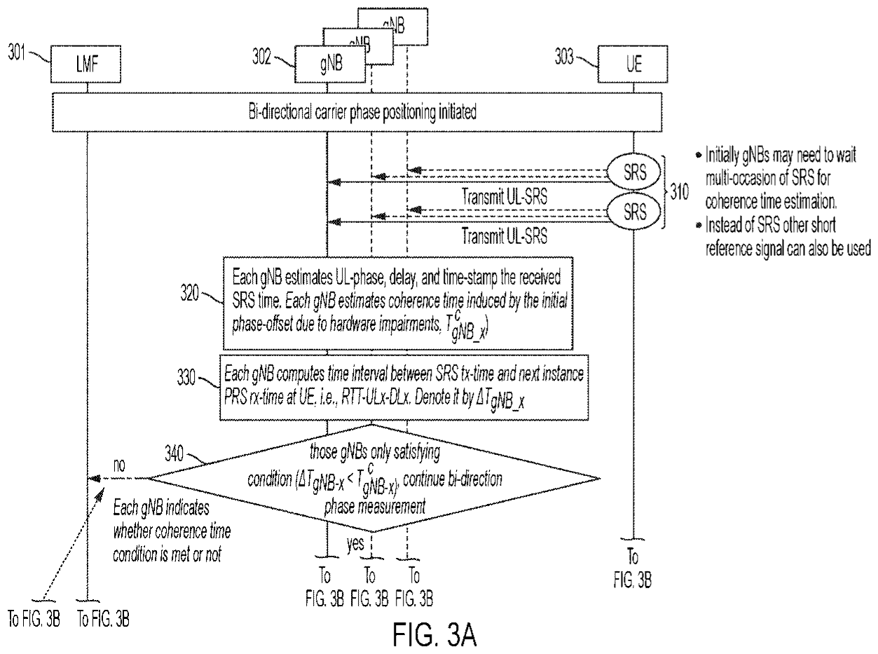

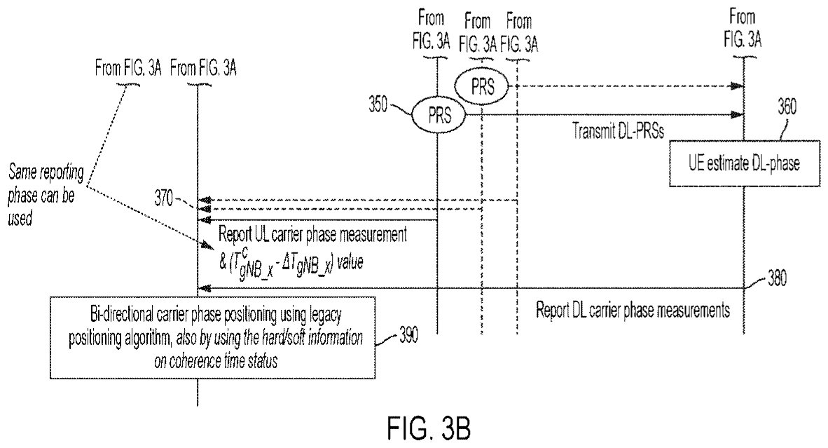

FIGS. 3A and 3B illustrate an exemplary signal diagram of one or more procedures to account for a variation in an initial phase-offset in the RTT carrier phase measurement and positioning, according to various exemplary embodiments. In FIGS. 3A and 3B, the network includes an LMF 301, one or more base stations, such as gNBs (3 gNBs in this example—each designated by 302), and a UE 303. The exemplary procedure shown in FIGS. 3A and 3B occurs when bi-directional carrier phase positioning is initiated.

In FIG. 3A, at 310, the UE 303 may transmit a UL-SRS (or another UL or DL reference signal, such as, for example a primary synchronization signal (PSS), a secondary synchronization signal, a demodulation reference signal, a channel state information reference signal, and the like) to each of the gNBs 302. Multiple UL-SRSs may be used, for example, to estimate a variation of phase or initial-phase measurement. Further, for RTT-CP estimation/positioning, a period for the estimation of coherence time of initial phase-offset may be defined after which an actual RTT-phase measurement may occur, or a periodic UL or DL (SRS or PRS) may be utilized to estimate a coherence time.

At 320, each of the gNBs 302 may estimate a UL-phase, a delay value, and a time stamp for the received SRS time. Each gNB 302 may calculate or estimate a coherence time induced by the initial phase-offset due to any hardware impairments

$${T}_{gNB \_ x}^{c} .$$

At 330, each of the gNBs 302 may calculate a time interval ΔT_{gNB_x} between an SRS transmission time (Tx-time) and a next instance of a PRS reception time (Rx-time) at the UE 303 (RTT-ULx-DLx).

In FIGS. 3A and 3B, at 340, each of the gNBs 302 may determine whether a coherence time condition of ΔT_{gNB_x}<TgNB_xc has been satisfied. If the coherence time condition is not satisfied for each gNB 302, the respective gNB 302 may inform and/or signal the LMF 301 that the coherence time condition has not been satisfied. If the coherence time condition is satisfied for each gNB 302, the respective gNB 302 may continue with the bi-directional phase measurement procedure and proceed to 350. At 350, the gNBs 302 that satisfied the coherence time condition may transmit a DL-PRS to the UE 303. At 360, the UE 303 may estimate a DL carrier-phase measurement based on the DL-PRSs received from the gNBs 302 that satisfied the coherence time condition.

At 370 of FIG. 3B, the gNBs may report, to the LMF 301, a UL carrier phase measurement value and a value of a difference between ΔT_{gNB_x} and

$${T}_{gNB \_ x}^{c} ( {T}_{gNB \_ x}^{c} - Δ TgNB\_x ) .$$

At 380, the UE 303 may report a DL carrier phase measurement to the LMF 301. At 390, the LMF 301 may perform bi-directional carrier phase positioning using legacy positioning algorithms and using the hard information and soft information on coherence time status.

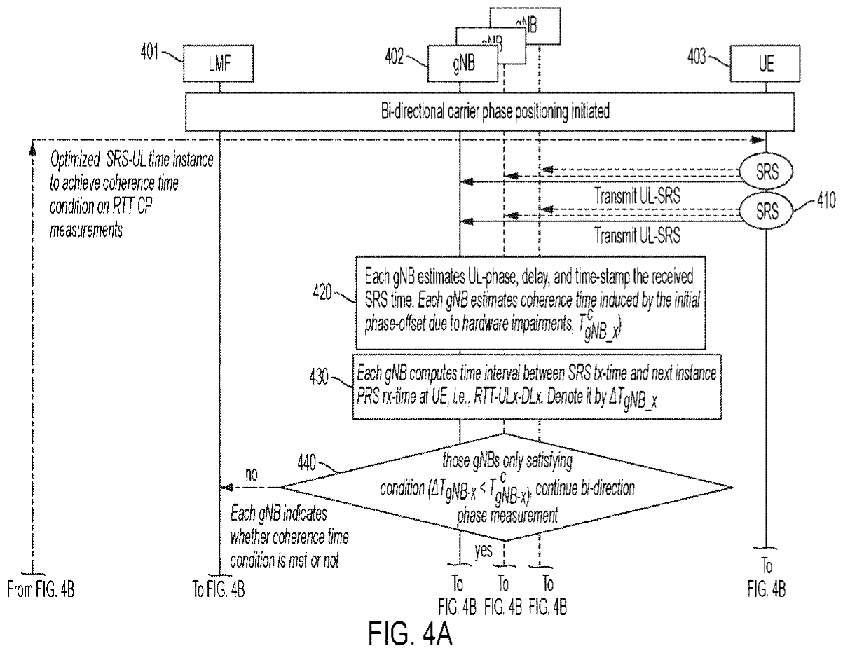

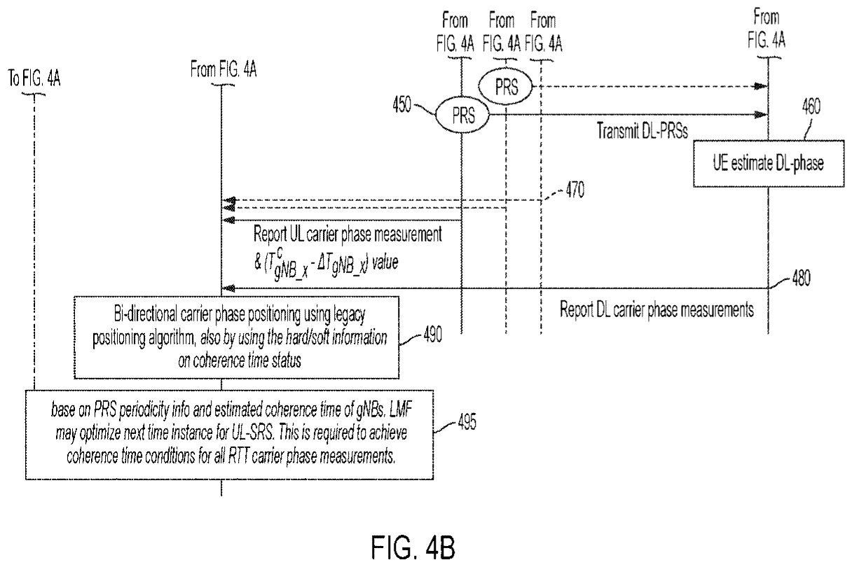

FIGS. 4A and 4B illustrate another exemplary signal diagram of one or more additional or alternative procedures to account for a variation in an initial phase-offset in the RTT carrier phase measurement and positioning, according to certain exemplary embodiments. The LMF may further optimize the time instances (periodicities) of UL-SRS and DL-PRS to achieve significant thresholds on the condition of RTT charrier phase measurements. An increase in the confidence level of the RTT-CP measurements may be achieve by increasing a margin, which may be performed by LMF using collected soft information of coherence-time conditions and the timing/periodicity of UL-SRS and DL-PRS. The margin may be a margin that each gNB may be able to maintain.

The exemplary procedure shown in FIGS. 4A and 4B may occur when bi-directional carrier phase positioning is initiated. At 410, the UE 403 may transmit a UL-SRS (or another uplink reference signal) to each of the gNBs 402. At 420, each of the gNBs 402 may estimate a UL carrier-phase measurement, a delay value, and a time stamp for the received SRS time. Each gNB 402 may calculate or estimate a coherence time induced by the initial phase-offset due to any hardware impairments

$${T}_{gNB \_ x}^{c} .$$

At 430, each of the gNBs 402 may compute a time interval ΔT_{gNB_x} between SRS Tx-time and a next instance of a PRS Rx-time at the UE 403 (RTT-ULx-DLx).

At 440 in FIG. 4A, each of the gNBs 402 may determine whether a coherence time condition of ΔT_{gNB_x}<TgNB_xc has been satisfied. If the coherence time condition is not satisfied for each gNB 402, the respective gNB 402 may inform and/or signal the LMF 401 that the coherence time condition has not been satisfied. If the coherence time condition is satisfied for each gNB 402, the respective gNB 402 may continue with the bi-directional phase measurement procedure and proceed to 450. At 450, the gNBs 402 that satisfied the coherence time condition may transmit a DL-PRS to the UE 403. At 460, the UE 403 may estimate a DL-phase based on the DL-PRSs received from the gNBs 402 that satisfied the coherence time condition.

At 470 of FIG. 4B, the gNBs 402 may report, to the LMF 401, a UL carrier phase measurement value and a value of a difference between ΔT_{gNB_x} and

$${T}_{gNB \_ x}^{c} ( {T}_{gNB \_ x}^{c} - Δ TgNB\_x ) .$$

At 480, the UE 403 may report a DL carrier phase measurement to the LMF 401. At 490, the LMF 401 may perform bi-directional carrier phase positioning using legacy positioning algorithms and using the hard information and soft information on coherence time status. At 495, the LMF 401 may optimize a next time instance for the UL-SRS based on a PRS periodicity and estimated coherence time of the gNBs 402, which may be required to achieve coherence time conditions for all bi-directional (RTT) carrier phase measurements. The LMF 401 may optimize the next time instance for the UL-SRS by returning to 410 and use the optimized UL-SRS to again perform procedures 410-490 or procedures 410-495.

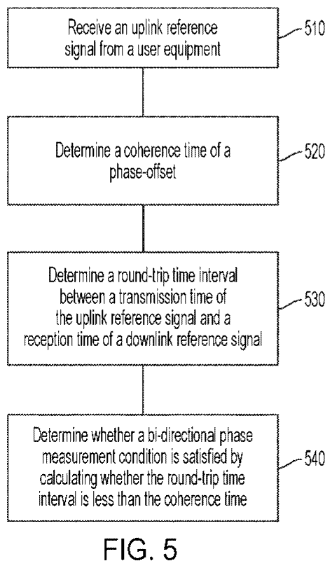

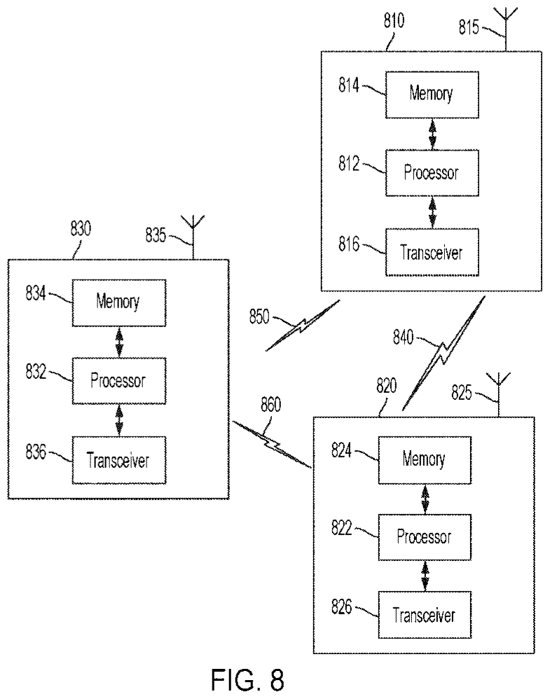

FIG. 5 illustrates an example flow diagram of a method, according to certain exemplary embodiments. In an example embodiment, the method of FIG. 5 may be performed by a network element, or a group of multiple network elements in a 3GPP system, such as LTE or 5G-NR. For instance, in an exemplary embodiment, the method of FIG. 5 may be performed by a network device or network entity, such as a base station or gNB, similar to apparatus 820 illustrated in FIG. 8.

According to various exemplary embodiments, the method of FIG. 5 may include, at 510, receiving a UL reference signal from a UE, and at 520, determining a coherence time of a phase-offset. The method may further include, at 530, determining an RTT interval between a transmission time of the UL reference signal and a reception time of a DL reference signal. At 540, the method may include determining whether a bi-directional phase measurement condition is satisfied by calculating whether the round-trip time interval is less than the coherence time.

According to certain exemplary embodiments, the method may further include updating the coherence time of the phase-offset for each periodic reception of the UL reference signal.

According to some exemplary embodiments, the method may also include reporting, to a location server, such as an LMF, of a network, a carrier phase measurement and a time difference between the coherence time and the round-trip time interval. Some exemplary embodiments may provide that the method may further include, when the bi-directional phase measurement condition is not satisfied, transmitting an indication to the location server indicating that the bi-directional phase measurement condition is not satisfied. When the bi-directional phase measurement condition is satisfied, the method may further include transmitting a DL reference signal to the UE.

Various exemplary embodiments may provide that the method may further include transmitting the DL reference signal to the UE regardless of whether the bi-directional phase measurement condition is determined to be satisfied or not. The coherence time may be determined based on a pre-determined coherence time, which may be determined by the UE and provided to the gNB by the location server. The UL reference signal may be a sounding reference signal, and the DL reference signal may be a DL positioning reference signal.

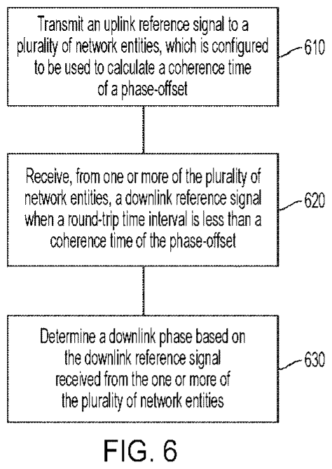

FIG. 6 illustrates an example flow diagram of a method, according to certain exemplary embodiments. In an example embodiment, the method of FIG. 6 may be performed by a network element, or a group of multiple network elements in a 3GPP system, such as LTE or 5G-NR. For instance, in an exemplary embodiment, the method of FIG. 6 may be performed by a user device, mobile device, etc., such as a UE, similar to apparatus 810 illustrated in FIG. 8.

According to various exemplary embodiments, the method of FIG. 6 may include, at 610, transmitting a UL reference signal to a plurality of network entities similar to apparatus 820, which may be configured to be used to calculate a coherence time of a phase-offset. At 620, the method may further include receiving, from one or more of the plurality of network entities, a DL reference signal when an RTT interval is less than the coherence time of the phase offset. The RTT interval may be a time interval between a transmission time of the UL reference signal and a reception time of the DL reference signal by each of the one or more of the plurality of network entities. The method may further include, at 630, determining a DL phase based on the DL reference signal received from the one or more of the plurality of network entities.

Certain exemplary embodiments may provide that the UL reference signal may be periodically transmitted to each of the plurality of network entities such that the coherence time of the phase-offset may be updated each time the uplink reference signal is transmitted.

According to some exemplary embodiments, the method may include receiving the DL reference signal from each of the one or more of the plurality of network entities when a bi-directional phase measurement condition is satisfied. The bi-directional phase measurement condition may be satisfied by calculating that the RTT interval is less than the coherence time. For example, in certain exemplary embodiments, the DL reference signal may be received by the apparatus 810 regardless of whether the bi-directional phase measurement condition is determined to be satisfied or not.

Various exemplary embodiments may provide that the method also includes pre-determining the coherence time and transmitting the predetermined coherence time to location server, such as an LMF, of a network. The uplink reference signal may be a sounding reference signal and the DL reference signal may be a DL positioning reference signal.

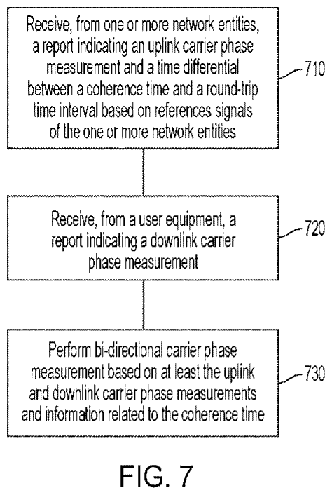

FIG. 7 illustrates an example flow diagram of a method, according to certain exemplary embodiments. In an example embodiment, the method of FIG. 7 may be performed by a network element, or a group of multiple network elements in a 3GPP system, such as LTE or 5G-NR. For instance, in an exemplary embodiment, the method of FIG. 7 may be performed by the network, a part of the network, or a network entity, such as an LMF, similar to apparatus 830 illustrated in FIG. 8.

According to various exemplary embodiments, the method of FIG. 7 may include, at 710, receiving, from one or more network entities similar to apparatus 820, a report indicating a UL carrier phase measurement and a time differential between a coherence time and an RTT interval based on reference signals of the one or more network entities. At 720, the method may also include receiving, from a UE similar to apparatus 810, a report indicating a DL carrier phase measurement, and at 730, performing bi-directional carrier phase measurement based on at least the UL and DL carrier phase measurements and information related to the coherence time.

Some exemplary embodiments may provide that the method further includes receiving, from one or more of the plurality of network entities, information indicating at least that a bi-directional phase measurement condition has not been satisfied by the respective one or more of the plurality of network entities. The bi-directional phase measurement condition may be based on calculating a difference between the RTT interval and the coherence time of the reference signals. The bi-directional phase measurement condition may be satisfied by calculating that the RTT interval is less than the coherence time.

Certain exemplary embodiments may provide that the RTT interval may be a time interval between a transmission time of the UL reference signal by the UE and a reception time of the DL reference signal by each of the plurality of network entities. Further, the coherence time may be a coherence time induced by an initial phase-offset in the UL reference signal.

According to various exemplary embodiments, the method may further include receiving, from the UE, a pre-determined coherence time to be used as the coherence time and transmitting the pre-determined coherence time to the plurality of network entities. The pre-determined coherence time may be determined by the UE. The UL reference signal may be a sounding reference signal, and the DL reference signal may be a DL positioning reference signal.

FIG. 8 illustrates apparatuses 810, 820, and 830 according to various exemplary embodiments. In the various exemplary embodiments, apparatus 810 may be an element in a communications network or associated with such a network, such as a UE, RedCap UE, SL UE, mobile equipment (ME), mobile station, mobile device, stationary device, IoT device, or other device. UE 303 and 403 may be examples of apparatus 810 according to various exemplary embodiments as discussed above. It should be noted that one of ordinary skill in the art would understand that apparatus 810 may include components or features not shown in FIG. 8. Further, the apparatus 820 may be a network entity, element of the core network, or element in a communications network or associated with such a network, such as a base station, an NE, or a gNB. For example, gNB 302 and 402 may be examples of apparatus 820 according to various exemplary embodiments as discussed above. It should be noted that one of ordinary skill in the art would understand that apparatus 820 may include components or features not shown in FIG. 8. In addition, an apparatus 830 may be a part of the RAN, a network entity or a sub-component or processing functions of a network entity of computation device connected to the network, such as an LMF. For example, LMF 301 and 401 may be examples of apparatus 830 according to various exemplary embodiments as discussed above. It should be noted that one of ordinary skill in the art would understand that apparatus 830 may include components or features not shown in FIG. 8.

Various exemplary embodiments may advantageously provide one or more procedures to increase the accuracy of carrier phase-based positioning by the RTT-ULx-DLx duration ΔT of the UL and DL carrier phase measurements being within the coherence-time induced by the initial phase-offset variations due to hardware impairments over time, even for the static UE.

According to various exemplary embodiments, the apparatuses 810, 820, and/or 830 may include one or more processors, one or more computer-readable storage medium (for example, memory, storage, or the like), one or more radio access components (for example, a modem, a transceiver, or the like), and/or a user interface. In some exemplary embodiments, apparatuses 810, 820, and/or 830 may be configured to operate using one or more radio access technologies, such as GSM, LTE, LTE-A, NR, 5G, WLAN, WiFi, NB-IoT, Bluetooth, NFC, MulteFire, and/or any other radio access technologies.

As illustrated in the example of FIG. 8, apparatuses 810, 820, and/or 830 may include or be coupled to processors 812, 822, and 832, respectively, for processing information and executing instructions or operations. Processors 812, 822, and 832 may be any type of general or specific purpose processor. In fact, processors 812, 822, and 832 may include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples. While a single processor 812 (822 and 832) for each of apparatuses 810, 820, and/or 830 is shown in FIG. 8, multiple processors may be utilized according to other example embodiments. For example, it should be understood that, in certain example embodiments, apparatuses 810, 820, and/or 830 may include two or more processors that may form a multiprocessor system (for example, in this case processors 812, 822, and 832 may represent a multiprocessor) that may support multiprocessing. According to certain example embodiments, the multiprocessor system may be tightly coupled or loosely coupled to, for example, form a computer cluster).

Processors 812, 822, and 832 may perform functions associated with the operation of apparatuses 810, 820, and/or 830, respectively, including, as some examples, precoding of antenna gain/phase parameters, encoding and decoding of individual bits forming a communication message, formatting of information, and overall control of the apparatuses 810, 820, and/or 830, including processes illustrated in FIGS. 3A-7.

Apparatuses 810, 820, and/or 830 may further include or be coupled to memory 814, 824, and/or 834 (internal or external), respectively, which may be coupled to processors 812, 822, and 832, respectively, for storing information and instructions that may be executed by processors 812, 822, and 832. Memory 814 (memory 824 and 834) may be one or more memories and of any type suitable to the local application environment, and may be implemented using any suitable volatile or nonvolatile data storage technology such as a semiconductor-based memory device, a magnetic memory device and system, an optical memory device and system, fixed memory, and/or removable memory. For example, memory 814 (memory 824 and 834) can be comprised of any combination of random access memory (RAM), read only memory (ROM), static storage such as a magnetic or optical disk, hard disk drive (HDD), or any other type of non-transitory machine or computer readable media. The instructions stored in memory 814, memory 824, and memory 834 may include program instructions or computer program code that, when executed by processors 812, 822, and 832, enable the apparatuses 810, 820, and/or 830 to perform tasks as described herein.

In certain example embodiments, apparatuses 810, 820, and/or 830 may further include or be coupled to (internal or external) a drive or port that is configured to accept and read an external computer readable storage medium, such as an optical disc, USB drive, flash drive, or any other storage medium. For example, the external computer readable storage medium may store a computer program or software for execution by processors 812, 822, and 832 and/or apparatuses 810, 820, and/or 830 to perform any of the methods illustrated in FIGS. 3A-7.

In some exemplary embodiments, apparatuses 810, 820, and/or 830 may also include or be coupled to one or more antennas 815, 825, and 835, respectively, for receiving a downlink signal and for transmitting via an uplink from apparatuses 810, 820, and/or 830.

Apparatuses 810, 820, and/or 830 may further include transceivers 816, 826, and 836, respectively, configured to transmit and receive information. The transceivers 816, 826, and 836 may also include a radio interface (for example, a modem) respectively coupled to the antennas 815, 825, and 835. The radio interface may correspond to a plurality of radio access technologies including one or more of GSM, LTE, LTE-A, 5G, NR, WLAN, NB-IoT, Bluetooth, BT-LE, NFC, RFID, UWB, or the like. The radio interface may include other components, such as filters, converters (for example, digital-to-analog converters or the like), symbol demappers, signal shaping components, an Inverse Fast Fourier Transform (IFFT) module, or the like, to process symbols, such as OFDMA symbols, carried by a downlink or an uplink.

For instance, transceivers 816, 826, and 836 may be respectively configured to modulate information on to a carrier waveform for transmission by the antenna(s) 815, 825, and 835, and demodulate information received via the antenna(s) 815, 825, and 835 for further processing by other elements of apparatuses 810, 820, and/or 830. In other example embodiments, transceivers 816, 826, and 836 may be capable of transmitting and receiving signals or data directly. Additionally or alternatively, in some example embodiments, apparatuses 810, 820, and/or 830 may include an input and/or output device (I/O device). In certain example embodiments, apparatuses 810, 820, and/or 830 may further include a user interface, such as a graphical user interface or touchscreen.

In certain example embodiments, memory 814, memory 824, and memory 834 store software modules that provide functionality when executed by processors 812, 822, and 832, respectively. The modules may include, for example, an operating system that provides operating system functionality for apparatuses 810, 820, and/or 830. The memory may also store one or more functional modules, such as an application or program, to provide additional functionality for apparatuses 810, 820, and/or 830. The components of apparatuses 810, 820, and/or 830 may be implemented in hardware, or as any suitable combination of hardware and software. According to certain example embodiments, apparatus 810 may optionally be configured to communicate with apparatus 820 and/or 830 via a wireless or wired communications links 840, 850, and/or 860 according to any radio access technology, such as NR.

According to certain example embodiments, processors 812, 822, and 832, and memory 814, 824, and 834 may be included in or may form a part of processing circuitry or control circuitry. In addition, in some example embodiments, transceivers 816, 826, and 836 may be included in or may form a part of transceiving circuitry.

For instance, in certain exemplary embodiments, the apparatus 810 may be controlled by the memory 814 and the processor 812 to transmit an uplink reference signal to a plurality of network entities, which is configured to be used to calculate a coherence time of a phase-offset. The apparatus 810 may be further caused to receive, from one or more of the plurality of network entities, a downlink reference signal when a round-trip time interval is less than the coherence time of the phase-offset. The round-trip time interval may be a time interval between a transmission time of the uplink reference signal and a reception time of the downlink reference signal by each of the one or more of the plurality of network entities. The apparatus 810 may also be caused to determine a downlink phase based on the downlink reference signal received from the one or more of the plurality of network entities.

In various exemplary embodiments, the apparatus 820 may be controlled by the memory 824 and the processor 822 to receive an uplink reference signal from a user equipment and determine a coherence time of a phase-offset. The apparatus 820 may be further caused to determine a round-trip time interval between a transmission time of the uplink reference signal and a reception time of a downlink reference signal, and determine whether a bi-directional phase measurement condition is satisfied by calculating whether the round-trip time interval is less than the coherence time.

In various exemplary embodiments, the apparatus 830 may be controlled by the memory 834 and the processor 832 to receive, from one or more network entities, a report indicating an uplink carrier phase measurement and a time differential between a coherence time and a round-trip time interval based on reference signals of the one or more network entities. The apparatus 830 may be further caused to receive, from a user equipment, a report indicating a downlink carrier phase measurement, and perform bi-directional carrier phase measurement based on at least the uplink and downlink carrier phase measurements and information related to the coherence time.

In some exemplary embodiments, an apparatus (e.g., apparatus 810, apparatus 820, and/or apparatus 830) may include means for performing a method, a process, or any of the variants discussed herein. Examples of the means may include one or more processors, memory, controllers, transmitters, receivers, and/or computer program code for causing the performance of the operations.

Various exemplary embodiments may be directed to an apparatus, such as apparatus 810, that includes means for transmitting an uplink reference signal to a plurality of network entities, which is configured to be used to calculate a coherence time of a phase-offset. The apparatus may also include means for receiving, from one or more of the plurality of network entities, a downlink reference signal when a round-trip time interval is less than the coherence time of the phase-offset. The round-trip time interval may be a time interval between a transmission time of the uplink reference signal and a reception time of the downlink reference signal by each of the one or more of the plurality of network entities. The apparatus may further include means for determining a downlink phase based on the downlink reference signal received from the one or more of the plurality of network entities.

Various exemplary embodiments may be directed to an apparatus, such as apparatus 820, that includes means for receive an uplink reference signal from a user equipment, and means for determining a coherence time of a phase-offset. The apparatus may also include means for determining a round-trip time interval between a transmission time of the uplink reference signal and a reception time of a downlink reference signal. The apparatus may further include means for determining whether a bi-directional phase measurement condition is satisfied by calculating whether the round-trip time interval is less than the coherence time.

Various exemplary embodiments may be directed to an apparatus, such as apparatus 830, that includes means for receiving, from one or more network entities, a report indicating an uplink carrier phase measurement and a time differential between a coherence time and a round-trip time interval based on reference signals of the one or more network entities. The apparatus may also include means for receiving, from a user equipment, a report indicating a downlink carrier phase measurement, and means for performing bi-directional carrier phase measurement based on at least the uplink and downlink carrier phase measurements and information related to the coherence time.

As used herein, the term “circuitry” may refer to hardware-only circuitry implementations (for example, analog and/or digital circuitry), combinations of hardware circuits and software, combinations of analog and/or digital hardware circuits with software/firmware, any portions of hardware processor(s) with software, including digital signal processors, that work together to cause an apparatus (for example, apparatus 810, 820, and/or 830) to perform various functions, and/or hardware circuit(s) and/or processor(s), or portions thereof, that use software for operation but where the software may not be present when it is not needed for operation. As a further example, as used herein, the term “circuitry” may also cover an implementation of merely a hardware circuit or processor or multiple processors, or portion of a hardware circuit or processor, and the accompanying software and/or firmware. The term circuitry may also cover, for example, a baseband integrated circuit in a server, cellular network node or device, or other computing or network device.

A computer program product may include one or more computer-executable components which, when the program is run, are configured to carry out some example embodiments. The one or more computer-executable components may be at least one software code or portions of it. Modifications and configurations required for implementing functionality of certain example embodiments may be performed as routine(s), which may be implemented as added or updated software routine(s). Software routine(s) may be downloaded into the apparatus.

As an example, software or a computer program code or portions of it may be in a source code form, object code form, or in some intermediate form, and it may be stored in some sort of carrier, distribution medium, or computer readable medium, which may be any entity or device capable of carrying the program. Such carriers may include a record medium, computer memory, read-only memory, photoelectrical and/or electrical carrier signal, telecommunications signal, and software distribution package, for example. Depending on the processing power needed, the computer program may be executed in a single electronic digital computer or it may be distributed amongst a number of computers. The computer readable medium or computer readable storage medium may be a non-transitory medium.

In other example embodiments, the functionality may be performed by hardware or circuitry included in an apparatus (for example, apparatuses 810, 820, and/or 830), for example through the use of an application specific integrated circuit (ASIC), a programmable gate array (PGA), a field programmable gate array (FPGA), or any other combination of hardware and software. In yet another example embodiment, the functionality may be implemented as a signal, a non-tangible means that can be carried by an electromagnetic signal downloaded from the Internet or other network.

According to certain example embodiments, an apparatus, such as a node, device, or a corresponding component, may be configured as circuitry, a computer or a microprocessor, such as single-chip computer element, or as a chipset, including at least a memory for providing storage capacity used for arithmetic operation and an operation processor for executing the arithmetic operation.

The features, structures, or characteristics of example embodiments described throughout this specification may be combined in any suitable manner in one or more example embodiments. For example, the usage of the phrases “certain embodiments,” “an example embodiment,” “some embodiments,” or other similar language, throughout this specification refers to the fact that a particular feature, structure, or characteristic described in connection with an embodiment may be included in at least one embodiment. Thus, appearances of the phrases “in certain embodiments,” “an example embodiment,” “in some embodiments,” “in other embodiments,” or other similar language, throughout this specification do not necessarily refer to the same group of embodiments, and the described features, structures, or characteristics may be combined in any suitable manner in one or more example embodiments. Further, the terms “cell”, “node”, “gNB”, or other similar language throughout this specification may be used interchangeably.

As used herein, “at least one of the following: <a list of two or more elements>” and “at least one of <a list of two or more elements>” and similar wording, where the list of two or more elements are joined by “and” or “or,” mean at least any one of the elements, or at least any two or more of the elements, or at least all the elements.

One having ordinary skill in the art will readily understand that the disclosure as discussed above may be practiced with procedures in a different order, and/or with hardware elements in configurations which are different than those which are disclosed. Therefore, although the disclosure has been described based upon these example embodiments, it would be apparent to those of skill in the art that certain modifications, variations, and alternative constructions would be apparent, while remaining within the spirit and scope of example embodiments. Although the above embodiments refer to 5G NR and LTE technology, the above embodiments may also apply to any other present or future 3GPP technology, such as LTE-advanced, and/or fourth generation (4G) technology.

### PARTIAL GLOSSARY

3GPP 3rd Generation Partnership Project
5G 5th Generation
CP Carrier Phase
DL Downlink
DLx Downlink Transmission
EMBB Enhanced Mobile Broadband
gNB 5G or Next Generation NodeB
LMF Location Management Function
LPP LTE Positioning Protocol
LTE Long Term Evolution
NR New Radio
PFL Positioning Frequency Layer
PRS Positioning Reference Signal
PRU Positioning Reference Unit
RAN Radio Access Network
RedCap Reduced Capability
RTT Round Trip Time
SRS Sounding Reference Signal
TRP Transmission Reception Point
UE User Equipment
UL Uplink
ULx Uplink Transmission
URLLC Ultra Reliable Low Latency Communication

1-69. (canceled)

70. An apparatus comprising:
a processor; and
a memory storing instructions that, when executed by the at least one processor, cause the apparatus at least to:
receive, from a user equipment, a periodic uplink sounding reference signal;
estimate, based on the periodic uplink sounding reference signal, a coherence time induced by variation of an initial phase-offset associated with hardware impairments;
determine a round-trip time interval between a transmission time of the uplink sounding reference signal and a next instance of a downlink positioning reference signal to be received at the user equipment;
determine a time difference between the coherence time and the round-trip time interval;
determine whether a bi-directional carrier phase measurement condition is satisfied based on whether the round-trip time interval is less than the coherence time;
based on the bi-directional carrier phase measurement condition being satisfied, transmit the downlink positioning reference signal to the user equipment; and
report, to a location management function of a network, at least one uplink carrier phase measurement and the determined time difference between the coherence time and the round-trip time interval.

71. The apparatus according to claim 70, wherein the coherence time is estimated based on variation of the initial phase-offset observed across multiple periodic receptions of the uplink sounding reference signal.

72. The apparatus according to claim 71, wherein the initial phase-offset variation is associated with oscillator drift, timing alignment error, frequency offset, or local oscillator initial phase variation.

73. The apparatus according to claim 72, wherein the round-trip time interval comprises a time duration between transmission of the uplink sounding reference signal by the user equipment and reception of the downlink positioning reference signal at the user equipment including an estimated propagation delay.

74. The apparatus according to claim 73, wherein the apparatus is further caused to update the estimated coherence time for each periodic reception of the uplink sounding reference signal.

75. The apparatus according to claim 74, wherein the report to the location management function further includes an indication of whether the bi-directional carrier phase measurement condition has been satisfied.

76. The apparatus according to claim 75, wherein the determined time difference between the coherence time and the round-trip time interval is reported as soft information for filtering positioning measurements at the location management function.

77. The apparatus according to claim 76, wherein the apparatus refrains from transmitting the downlink positioning reference signal when the round-trip time interval is not less than the coherence time.

78. The apparatus according to claim 77, wherein the uplink sounding reference signal is transmitted by the user equipment to a plurality of network entities substantially simultaneously to enable each network entity to estimate a respective coherence time.

79. The apparatus according to claim 78, wherein the location management function optimizes a subsequent transmission instance of the periodic uplink sounding reference signal based on the reported time difference between the coherence time and the round-trip time interval.

80. An apparatus comprising:
at least one processor; and
at least one memory storing instructions that, when executed by the at least one processor, cause the apparatus at least to:
periodically transmit, to a plurality of network entities, an uplink sounding reference signal configured to enable each of the plurality of network entities to estimate a coherence time induced by variation of an initial phase-offset associated with hardware impairments;
receive, from one or more of the plurality of network entities, a downlink positioning reference signal transmitted in response to a determination that a round-trip time interval between transmission of the uplink sounding reference signal and reception of the downlink positioning reference signal is less than the coherence time estimated by the respective network entity;
determine a downlink carrier phase measurement based on the received downlink positioning reference signal; and
report the downlink carrier phase measurement to a location management function of a network for use in bi-directional carrier phase positioning.

81. The apparatus according to claim 80, wherein the uplink sounding reference signal is transmitted during a coherence-time estimation period preceding initiation of bi-directional carrier phase positioning.

82. The apparatus according to claim 81, wherein the uplink sounding reference signal is transmitted substantially simultaneously to the plurality of network entities to enable the plurality of network entities to perform carrier phase measurements at a similar time instance.

83. The apparatus according to claim 82, wherein the variation of the initial phase-offset is caused by at least one of oscillator drift, timing alignment error, frequency offset, or local oscillator initial phase variation.

84. The apparatus according to claim 83, wherein the round-trip time interval comprises a duration including uplink transmission time, downlink transmission time, and estimated propagation delay between the apparatus and the respective network entity.

85. The apparatus according to claim 84, wherein the downlink positioning reference signal is received only from network entities that determine that the round-trip time interval is less than the coherence time.

86. The apparatus according to claim 85, wherein the apparatus is further caused to receive the downlink positioning reference signal regardless of whether the round-trip time interval is less than the coherence time, and to report the downlink carrier phase measurement for filtering at the location management function.

87. The apparatus according to claim 86, wherein the downlink carrier phase measurement is based on a phase difference between a positioning reference signal from a reference transmission reception point and a positioning reference signal from a target transmission reception point.

88. The apparatus according to claim 87, wherein the location management function performs bi-directional carrier phase positioning using the reported downlink carrier phase measurement together with uplink carrier phase measurements and time-difference information received from the plurality of network entities.

89. The apparatus according to claim 88, wherein a periodicity of the uplink sounding reference signal is optimized by the location management function based on previously reported coherence-time-related information to satisfy the round-trip time interval condition.
